(19) United States
(12) Patent Application Publication
(10) Pub. No.: US 2003/0097497 A1
(43) Pub. Date: May 22, 2003

(54) Data format recognition for networks providing device interoperability

(76) Inventor: Jeffrey Esakov, Pennington, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/990,502

(22) Filed: Nov. 21, 2001

(51) Int. Cl. G06F 13/10

(52) U.S. Cl. 710/16

(57) ABSTRACT

A method for enabling interoperability between a first device and a second device in a network, such as a HAVi-compatible network, provides advantages over conventional methods. According to an aspect of the invention, a user input requesting the second device to decode data is received via the first device. The first device causes an initial portion of the data to be transmitted from a data source to the first device. The first device detects a data format exhibited by the initial portion of the data. The first device also causes the initial portion of the data and a remaining portion of the data to be sequentially transmitted to the second device. According to an exemplary embodiment, the second device decodes the initial portion of the data, and then decodes the remaining portion of the data. The initial and remaining portions of the data may include video and/or audio data.

### BACKGROUND OF THE INVENTION

1. Field of the Invention

The present invention generally relates to networks that provide interoperability among a plurality of devices such as consumer electronics devices, and more particularly, to a method for providing, among other things, a data format recognition scheme suitable for use in such networks.

### BACKGROUND INFORMATION

Networks that provide interoperability among various devices have been proposed in the consumer electronics industry. As an example, the Home Audio/Video Interoperability (“HAVi”) specification is a technical specification for interconnecting consumer electronics devices and computers based upon networking protocols prescribed by the Institute of Electrical and Electronic Engineers (“IEEE”) 1394 specification. The HAVi and IEEE 1394 specifications, including all versions, updates and revisions, are hereby incorporated by reference in their entireties.

The HAVi specification supports mechanisms for both isochronous and asynchronous data streaming, and is backward compatible with non-HAVi devices such as Digital Video (“DV”) enabled video cameras. The HAVi specification includes specific application program interfaces (“APIs”) for program interaction among various devices within a HAVi-compatible network. Such devices include, but are not limited to, televisions, digital versatile disk (“DVD”) players, video random access memory (“RAM”) disks, modems, displays and internet gateways. The HAVi specification addresses issues such as device discovery, device interaction, and device-to-device data flow.

One advantage of a network providing device interoperability such as a HAVi-compatible network is that a user can control multiple devices from a single point within the network. For example, from an appropriately enabled device a user can specify the display of video from a DV camera on a television monitor physically located in another room. Alternatively, the user could specify that video be retrieved from the internet or other source (e.g., RAM disk) and displayed on a monitor to which the applicable video decoder is connected.

To optimally facilitate data transmission within a network providing device interoperability such as a HAVi-compatible network, it is important to know the particular data format of data entering the network so that it may be routed to a network device capable of decoding the particular data format. Currently, device interoperability specifications such as the HAVi and IEEE 1394 specifications fail to address the issue of data format recognition. Accordingly, there is a need for a mechanism in which data formats can be recognized in networks that provide device interoperability.

One way to recognize the format of data is to cause some portion of the data to be read by a device, thus causing the read data to be consumed or lost. In some instances, the loss of data attributable to format recognition is not an issue since data decoding can begin at points other than the beginning of the data stream. However, in other situations, such as with data provided via the internet, it may not be possible or desirable to start decoding at any point other than the beginning of the data stream. Accordingly, there is a need in networks that provide device interoperability for a mechanism in which after the format of data is recognized, the data in its entirety can be routed to a given device. The present invention addresses these and other issues.

### SUMMARY OF THE INVENTION

The present invention provides, among other things, a method for enabling interoperability between a first device and a second device in a network, such as a HAVi-compatible network. According to an aspect of the invention, a user input requesting the second device to decode data is received via the first device. The first device causes an initial portion of the data to be transmitted from a data source to the first device. The first device detects a data format exhibited by the initial portion of the data. The first device also causes the initial portion of the data and a remaining portion of the data to be sequentially transmitted to the second device. According to an exemplary embodiment, the second device decodes the initial portion of the data, and then decodes the remaining portion of the data. The initial and remaining portions of the data may comprise video and/or audio data. According to the present invention, the data format may be recognized and routed in its entirety to a specified device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of an exemplary network capable of providing device interoperability;

FIG. 2 is a diagram of a first exemplary network suitable for implementing the present invention;

FIG. 3 is a diagram of a second exemplary network suitable for implementing the present invention; and

FIG. 4 is a flowchart illustrating exemplary steps for practicing the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

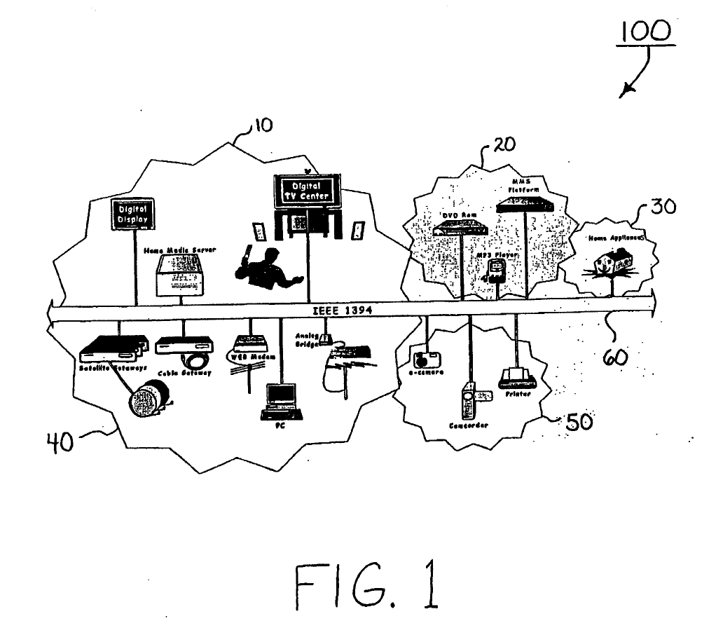

Referring now to the drawings, and more particularly to FIG. 1, a diagram of an exemplary network 100 capable of providing device interoperability is shown. For purposes of example and explanation, the network 100 of FIG. 1 may represent a HAVi-compatible network. In FIG. 1, the network 100 comprises a first exemplary set of network devices 10, a second exemplary set of network devices 20, a third exemplary set of network devices 30, a fourth exemplary set of network devices 40, a fifth exemplary set of network devices 50, and a network bus 60.

The first set of network devices 10 comprises a digital display device, a home media server and a digital television center. The second set of network devices 20 comprises a DVD RAM, a digital audio (“MP3”) player and a multimedia station (“MMS”) platform. The third set of network devices 30 comprises home appliances. The fourth set of network devices 40 comprises satellite gateways, a cable gateway, a web modem, a personal computer (“PC”) and an analog bridge. The fifth set of network devices 50 comprises an electronic (“e”) camera, a camcorder and a printer. The network bus 60 is shown in FIG. 1 as an IEEE 1394 bus, and provides a signal transmission medium through which the various sets of network devices 10 to 50 communicate and enable interoperability among themselves. For example, in operation a user of the first set of network devices 10 may enter a command to the digital television center causing the web modem of the fourth set of network devices 40 to retrieve data via the internet and provide the retrieved data over the network bus 60 for display at the digital television center. Of course, many other types of device interoperability may be provided within the network 100.

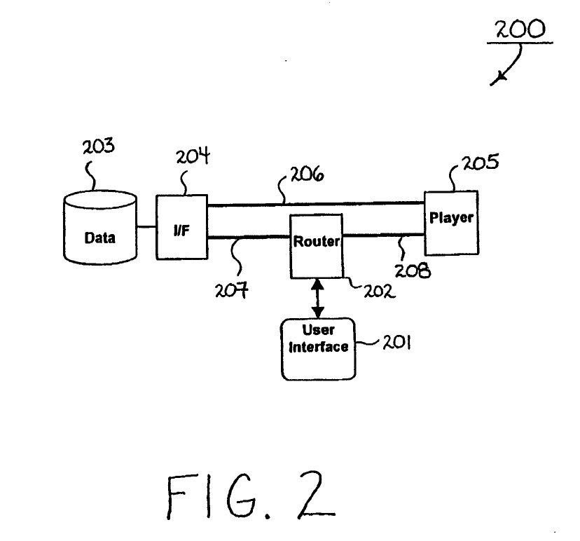

Referring now to FIG. 2, a diagram of a first exemplary network 200 suitable for implementing the present invention is shown. The network 200 of FIG. 2 is capable of providing device interoperability, and like the network 100 of FIG. 1, may represent a HAVi-compatible network. However, for purposes of example and explanation, the network 200 of FIG. 2 includes fewer components than the network 100 of FIG. 1. In particular, the network 200 comprises a user interface 201, a router 202, a data source 203, an interface (“I/F”) 204, a player 205, and network buses 206 through 208.

According to an exemplary embodiment, the user interface 201 is physically separate from the router 202 and may, for example, be embodied as a hand-held remote control unit, which may operate in combination with other input devices, such as a video display that provides On Screen Displays. According to this embodiment, the physically separate user interface 201 generates and outputs control signals (e.g., infrared signals) based on user inputs in order to control the router 202. The router 202 may be embodied, for example, as a dedicated signal routing device, or may be included in a device, such as a television signal receiver, a video cassette recorder (“VCR”), a DVD player, a set top box, a computer, or other device. Moreover, the router 202 may be equipped with a transcoding capability so as to convert data from one format to another format.

According to another embodiment, the user interface 201 may be embodied as an input terminal integral with the router 202. According to this embodiment, the user interface 201 and the router 202 may be combined into a single device, such as a dedicated signal routing device, a television signal receiver, a VCR, a DVD player, a set top box, a computer, or other device. In both embodiments, the router 202 provides, among other things, software-enabled functionality which enables signal format recognition, signal routing and other functions within the network 200, such functions may be implemented using the various methods known to those skilled in the art.

The data source 203 provides one or more types of data such as video data, audio data, internet protocol data and/or other types of data. According to an exemplary embodiment, each of these data types may be encoded in one or more formats. For example, video data may be encoded as Motion Picture Expert Group-Type 2 (“MPEG-2”) data, or other data. The data source 203 may, for example, be embodied as any type of data storage device such as a database, a CD, a DVD, a computer disk, a HDD, solid state memory, or other storage devices. Moreover, the data source 203 may also provide real-time data, such as video and/or audio data from a live television, radio, satellite, internet, or other broadcast.

The I/F 204 provides an interface between the data source 203 and the rest of the network 200. According to an exemplary embodiment, the I/F 204 may be embodied as a HAVi interface comprised of one or more software APIs defined by any version of the HAVi specification. The I/F 204 may be included in a device which contains the data source 203. For example, the I/F 204 may be a software API stored within a DVD player or other device.

The player 205 is a device for decoding data provided, for example, via the data source 203. The player 205 may be embodied as any type of data decoding device, such as a television signal receiver, a VCR, a DVD player, a set top box, a computer, or other device, and may, but does not necessarily, include a display terminal. The player 205 may be constructed to include the functionality of the router 202.

The network buses 206 through 208 provide signal transmission channels (i.e., physical or wireless) within the network 200. According to an exemplary embodiment, the network buses 206 through 208 are each embodied as an IEEE 1394 bus. However, it is contemplated that the network buses 206 through 208 may be embodied as signal transmission channels established according to other protocols that enable interoperability among devices.

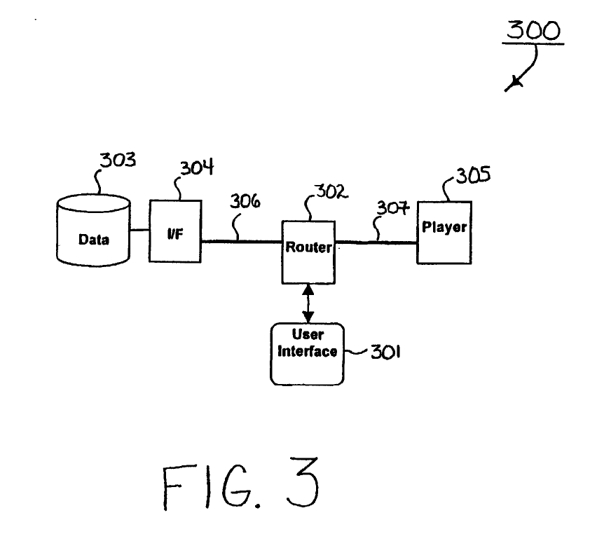

Referring to FIG. 3, a diagram of a second exemplary network 300 suitable for implementing the present invention is shown. Like the network 200 of FIG. 2, the network 300 of FIG. 3 is capable of providing device interoperability and may represent a HAVi-compatible network. In particular, the network 300 comprises a user interface 301, a router 302, a data source 303, an I/F 304, a player 305, and network buses 306 and 307. These components correspond to components in the network 200 of FIG. 2 having the same name. Accordingly, the network 300 of FIG. 3 is substantially identical to the network 200 of FIG. 2, except that the network 300 includes only two network buses, rather than three. Because of this difference, the network 300 has some different operational characteristics than the network 200, as will be discussed later herein.

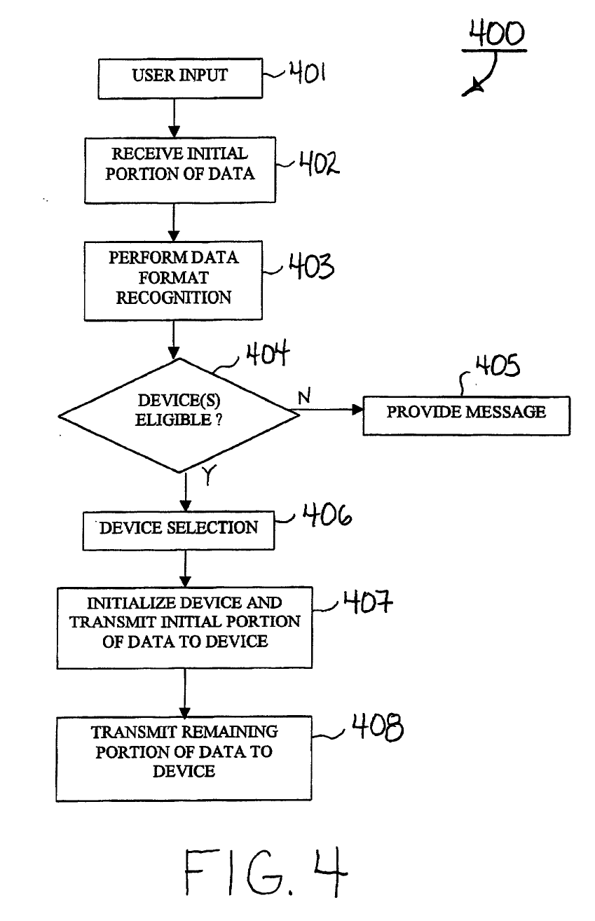

Referring now to FIG. 4, a flowchart illustrating exemplary steps for practicing the present invention is shown. For purposes of example and explanation, the steps of FIG. 4 will be described in relation to the exemplary networks 200 and 300 of FIGS. 2 and 3, respectively. Accordingly, the following description will refer to components shown in both FIGS. 2 and 3.

In FIG. 4, process flow begins at step 401 where a user provides an input to the router 202/302 via the user interface 201/301. According to an exemplary embodiment, the user input represents a request that a specific device (e.g., player 205/305) decode data provided from a particular data source (e.g., data source 203/303). According to another embodiment, the user input is more general and represents a request that an eligible device within the network 200/300 to be selected by the user decode data provided from a particular source. As used herein, a device that is both available (i.e., not currently in use) and capable of decoding a recognized data format may be referred to as an eligible device.

After the user input at step 401, process flow advances to step 402 where the router 202/302 receives an initial portion of the data from the data source 203/202 via the I/F 204/204 responsive to the user input. After receiving the initial portion of data at step 402, process flow advances to step 403 where the router 202/302 performs a data format recognition operation on the initial portion of data. According to an exemplary embodiment, the router 202/302 identifies the particular data format represented by the initial portion of data by comparing the data's packet headers to packet headers of known data formats. For example, the router 202/302 may determine that the initial portion of data represents MPEG-2 video data. In order to perform the format recognition operation, the router 202/302 typically requires at least four bytes of data. Accordingly, the initial portion of data should preferably comprise at least four bytes of data. However, it is noted that for some data formats, substantially more than four bytes of data may be required in order to recognize its format. It is also noted that other ways of performing format recognition (e.g., using meta-data) may be employed in accordance with the principles of the present invention.

After the data format recognition operation at step 403, process flow advances to step 404 where the router 202/302 makes a determination regarding device eligibility (i.e., decoding capability and availability). More specifically, if the user input at step 401 represents a request that a specific device perform a data decoding operation, then the router 202/302 determines at step 404 whether the specific device is an eligible device. However, if the user input at step 401 simply represents a request that an eligible device within the network 200/300 to be selected by the user perform a data decoding operation, then the router 202/302 determines at step 404 whether any devices within the network 200/300 are eligible devices. For example, in this latter case, if the data format recognized at step 403 is MPEG-2 video data, the router 202/203 determines at step 404 whether any devices within the network 200/300 are eligible devices (i.e., capable of decoding MPEG-2 video data and available). According to an exemplary embodiment, the router 202/302 stores data, or otherwise has access to data, which indicates the data decoding capabilities of the devices within the network 200/300. For example, data indicative of each network device's data decoding capabilities may be manually programmed into the router 202/302 via the user interface 201/301. Alternatively, such data may be automatically transmitted to the router 202/302 upon each device's installation within the network 200/300. Moreover, the router 202/302 is informed whenever any device within the network 200/300 is in use.

If the user requests a specific device at step 401 and the router 202/302 determines at step 404 that the specifically requested device is not eligible (i.e., not available and/or not capable of decoding the recognized data format), then process flow advances to step 405 where a user message is provided indicating that the specifically requested device is not eligible. In this case, as will be described later herein, the user may select another device assuming an eligible one exists. However, if the user simply requests an eligible device at step 401 and the router 202/302 determines at step 404 that no eligible device exists within the network 200/300, process flow likewise advances to step 405 where a user message is provided indicating that no eligible device exists. According to an exemplary embodiment, the user messages may be provided at step 405 via the user interface 201/301, or via a display terminal (not shown) on the router 202/302. According to another exemplary embodiment, in the event that no eligible device (including the specifically requested device) exists, the router 202/302 may perform a transcoding operation to convert received data to a particular format and thereby create an eligible device.

Alternatively, if the user requests a specific device at step 401 and the router 202/302 determines at step 404 that the specifically requested device is eligible, then process flow advances to step 406 where the specific device is automatically selected by the router 202/302. However, if the user simply requests an eligible device at step 401 and the router 202/302 determines at step 404 that at least one eligible device exists within the network 200/300, process flow likewise advances to step 406 where device selection by the user is enabled via the user interface 201/301. Moreover, assuming that at least one eligible device exists within the network 200/300, if the user requests a specific device at step 401 and the router 202/302 determines at step 404 that the specifically requested device is not eligible, then device selection by the user is enabled via the user interface 201/301 at step 406. According to an exemplary embodiment, to facilitate device selection at step 406, the router 202/302 provides a list of eligible devices to the user via the user interface 201/301, thus enabling the user to select a desired decoding device.

After device selection is performed at step 406, process flow advances to step 407 where the router 202/302 initializes the selected device, and transmits to the selected device the initial portion of data which was used for format recognition. In particular, the router 202/302 initializes the selected device by transmitting thereto a predetermined signal indicating that the device should prepare to begin a data decoding operation. For purposes of explanation and example, it is herein assumed that the player 205/305 is the selected device. Accordingly, at step 407, the router 202/302 initializes the player 205/305, and then transmits the initial portion of data to the player 205/305 via the network bus 208/307.

Then, at step 408, a remaining portion of the data is transmitted to the player 205/305. Step 408 is performed differently in the network 200 of FIG. 2 than in the network 300 of FIG. 3. In the network 200 of FIG. 2, step 408 is performed by the router 202 first transmitting a predetermined signal to the I/F 204 via the network bus 207, thereby creating a data path on the network bus 206 directly between the data source 203 and the player 205. Once the data path on the network bus 206 is established, the data source 203 may transmit the remaining portion of data to the player 205, or alternatively, the player 205 may read the remaining portion of data directly from the data source 203.

In contrast, in the network 300 of FIG. 3, step 408 is performed by the router 302 incrementally retrieving the remaining portion of data from the data source 303 via the I/F 304 and the network bus 306. The router 302 internally buffers the retrieved increments of the remaining portion of data, and then transmits the same to the player 305 via the network bus 307. According to an exemplary embodiment, the router 302 retrieves and buffers only small increments (e.g., one byte) of the remaining portion of data at a time in order to minimize the amount of required buffer capacity. In this manner, the router 302 can sequentially transmit the initial portion of data and then the remaining portion of data to the player 305, thereby enabling the player 305 to perform a lossless decoding operation without switching between data sources.

In both networks 200/300, the player 205/305 first decodes the initial portion of data, and then decodes the remaining portion of data. As indicated above, the network 300 of FIG. 3 enables the player 305 to perform a seamless, lossless decoding operation without switching between data sources since the router 302 sequentially transmits the initial and remaining portions of data to the player 305. The seamless. lossless operation enables display of data from dynamic sources, such as streaming media and broadcast data and other such data that is not easily restartable, to be performed on an eligible device in its entirety.

In the network 200 of FIG. 2, however, the player 205 must be able to switch midstream between two data sources in order to perform a seamless, lossless decoding operation. More specifically, the player 205 must be able to receive and decode the initial portion of data provided from the router 202, and then switch its inputs in a synchronous manner to receive and decode the remaining portion of data provided from the data source 203. It is noted, however, that the aforementioned switching capability of the player 205 can be eliminated by having the I/F 204 buffer the initial portion of data used by the router 202. In this manner, the I/F 204 can sequentially transmit the initial and remaining portions of data to the player 205 via the network bus 206. With this approach, the router 202 would not transmit the initial portion of data to the player 205 at step 407.

As described herein, the present invention advantageously provides, among other things, a data format recognition scheme suitable for use in networks that enable device interoperability, such as a HAVi-compatible network. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for enabling interoperability between a first device and a second device in a network, the method comprising steps of:
receiving via the first device, a user input requesting the second device to decode data;
causing via the first device, an initial portion of the data to be transmitted from a data source to the first device;
detecting via the first device, a data format exhibited by the initial portion of the data; and
causing via the first device, the initial portion of the data and a remaining portion of the data to be sequentially transmitted to the second device.

2. The method of claim 1, further comprised of the second device decoding the initial portion of the data, and then decoding the remaining portion of the data.

3. The method of claim 1, wherein the network is a HAVi-compatible network.

4. The method of claim 1, wherein the first device transmits the initial portion of the data to the second device, and enables the remaining portion of the data to be transmitted to the second device from the data source.

5. The method of claim 1, wherein the first device sequentially transmits the initial portion of the data and the remaining portion of the data to the second device.

6. The method of claim 1, wherein the initial portion of the data and the remaining portion of the data comprise video data.

7. The method of claim 1, wherein the initial portion of the data and the remaining portion of the data comprise audio data.

8. The method of claim 1, wherein the first device is a signal routing device.

9. In a network for providing interoperability between devices, a device for performing steps comprising:
receiving a user input requesting a second device within the network to decode data;
receiving an initial portion of the data from a data source;
detecting a data format exhibited by the initial portion of the data; and
enabling the initial portion of the data and a remaining portion of the data to be sequentially transmitted to the second device.

10. The device of claim 9, wherein the second device decodes the initial portion of the data, and then decodes the remaining portion of the data.

11. The device of claim 9, wherein the network is a HAVi-compatible network.

12. The device of claim 9, wherein the device enables the initial portion of the data and the remaining portion of the data to be sequentially transmitted to the second device by:
transmitting the initial portion of the data to the second device; and
enabling the remaining portion of the data to be transmitted to the second device from the data source.

13. The device of claim 9, wherein the device enables the initial portion of the data and the remaining portion of the data to be sequentially transmitted to the second device by:
transmitting the initial portion of the data to the second device; and
transmitting the remaining portion of the data to the second device.

14. The device of claim 9, wherein the initial portion of the data and the remaining portion of the data comprise video data.

15. The device of claim 9, wherein the initial portion of the data and the remaining portion of the data comprise audio data.

16. The device of claim 9, wherein the device is a signal routing device.
